(19) United States
(12) Patent Application Publication
(10) Pub. No.: US 2024/0166950 A1
(43) Pub. Date: May 23, 2024

(54) Oligomer Stabilized Liquid Crystal Light Valve

(71) Applicant: Seurat Technologies, Inc., Wilmington, MA (US)

(72) Inventor: Zoey Samuel Davidson, Cambridge, MA (US)

(21) Appl. No.: 18/515,558

(22) Filed: Nov. 21, 2023

Related U.S. Application Data
(60) Provisional application No. 63/427,306, filed on Nov. 22, 2022.

(51) Int. Cl. C09K 19/38; B29C 64/153; B29C 64/245; B29C 64/268; B33Y 30/00; B33Y 70/00; C09K 19/56; G02F 1/1337

(52) U.S. Cl. CPC C09K 19/3852; B29C 64/153; B29C 64/245; B29C 64/268; B33Y 30/00; B33Y 70/00; C09K 19/56; G02F 1/133784; B29K 2033/04; B29K 2995/0041

(57) ABSTRACT

A light modifying composition includes a first liquid crystal reactive mesogen material having attached functional groups that allow crosslinking. A second liquid crystal reactive mesogen material having attached functional groups and a differing molecular weight from the first liquid crystal reactive mesogen material is arranged to crosslink with the first crystal reactive mesogen material. For use in light valves, at least one of a photoalignment material and a rubbed LCD alignment material are contacted with the first and second liquid crystal reactive mesogen material.

### RELATED APPLICATION

The present disclosure is part of a non-provisional patent application claiming the priority benefit of U.S. Patent Application No. 63/427,306, filed on Nov. 22, 2022, which is incorporated by reference in its entirety.

### TECHNICAL FIELD

The present disclosure relates generally to the field of light valves and compositions for constructing light valves. More specifically, the present application relates to oligomer stabilized liquid crystal materials suitable for use in light valves.

### BACKGROUND

Light modulators can be used to completely or partially block, redirect, or modulate laser light. For example, a spatial light modulator (SLM), also known as a light valve (LV), is one type of light modulator that can be used to impress information equally across the entire beam (1D modulation), provide variation across the beam to form parallelized optical channels (2D modulation), or provide variations across a volume of pixels/voxels channels (3D modulation). The information imposed can be in the form of amplitude, phase, polarization, wavelength, coherency, or quantum entanglement.

Industrial applications can require that LVs withstand high fluence laser sources for a prolonged period of time. One often used light valve architecture relies on liquid crystals with aligned molecules sandwiched between transparent glass or other suitable substrate. Liquid crystal molecules can be roughly aligned using mechanical techniques (e.g. rubbing) or by non-contact photoalignment. Photoalignment encompasses a set of chemistries that enable large area non-contact liquid crystal (LC) alignment programming. Typically, a dichroic (i.e. polarization sensitive) dye is coated onto a substrate by standard processing methods (e.g. spin or dip). The coated substrate is then exposed to intense polarized light (usually blue or possibly UV wavelengths) which causes the dye molecules to orient to minimize absorption (typically perpendicular to the exposure polarization). This orientation sets the alignment of the liquid crystal molecules at that interface and thus the bulk liquid crystal director field.

Unfortunately, photoalignment dye is prone to rearrange further over time or on exposure to blue light after the liquid crystal is brought into contact at the interface. What is needed are reliable compositions and assembly techniques for manufacture of liquid crystal based light valves.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates an example material formed by combining varying monomers into an oligomer for use in a stabilized liquid crystal device;

FIG. 1B illustrates several example monomer units to be combined as depicted in FIG. 1A to form an oligomer;

FIG. 2A illustrates an example transmissive light valve structure;

FIG. 2B illustrates an example reflective light valve structure;

FIG. 3 illustrates an additive manufacturing system able to direct one or two dimensional light beams using a light valve including stabilized liquid crystal;

FIG. 4 illustrates a method for operation of an additive manufacturing system able to direct one or two dimensional light beams using a light valve including stabilized liquid crystal; and

FIG. 5 illustrates an additive manufacturing system able to direct one or two dimensional light beams using a light valve including stabilized liquid crystal and a switchyard systems.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

As used herein, the term “polymer” will be understood to mean a molecule that encompasses a backbone of one or more distinct types of repeating units (the smallest constitutional unit of the molecule) and is inclusive of the commonly known terms “oligomer”, “copolymer”, “homopolymer” and the like. Further, it will be understood that the term polymer is inclusive of, in addition to the polymer itself, residues from initiators, catalysts, and other elements attendant to the synthesis of such a polymer, where such residues are understood as not being covalently incorporated thereto. Further, such residues and other elements, while normally removed during post polymerization purification processes, are typically mixed or co-mingled with the polymer such that they generally remain with the polymer when it is transferred between vessels or between solvents or dispersion media.

The term “(meth)acrylic polymer” as used in the present invention includes a polymer obtained from acrylic monomers, a polymer obtainable from methacrylic monomers, and a corresponding co-polymer obtainable from mixtures of such monomers.

The term “polymerization” means the chemical process to form a polymer by bonding together multiple polymerizable groups or polymer precursors (polymerizable compounds) containing such polymerizable groups.

The terms “film” and “layer” include rigid or flexible, self-supporting or freestanding films with mechanical stability, as well as coatings or layers on a supporting substrate or between two substrates.

Liquid crystal based light valves or other optical equipment can be formed from a wide variety of mesogen material. A mesogen is a compound that displays liquid crystal properties (i.e. as disordered solids or ordered liquid) and can assume a liquid crystalline state (mesophase) that is intermediate between the crystalline solid state and the isotropic liquid state. The term “liquid crystal or mesogenic compound” can mean a compound comprising one or more calamitic (rod or board/lath-shaped) or discotic (disk-shaped) mesogenic groups. The term “mesogenic group” means a group with the ability to induce liquid crystal (LC) phase behavior. The compounds comprising mesogenic groups do not necessarily have to exhibit an LC phase themselves. It is also possible that they show LC phase behavior only in mixtures with other compounds, or when the mesogenic compounds or materials, or the mixtures thereof, are polymerized. For the sake of simplicity, the term “liquid crystal” is used hereinafter for both mesogenic and LC materials.

Commonly, liquid crystal properties occur because mesogenic compounds can be composed of both rigid and flexible parts. Rigid components align mesogen components in one direction while flexible segments provide mesogens with mobility. In many embodiments, flexible segments are based on alkyl chains that allow movement and hinder crystallization. The combination of rigid and flexible chains induce structural alignment and fluidity between liquid crystal moieties. In some embodiments, this combination of structural alignment and fluidity can be adjusted by stabilizing liquid crystal alignment with polymerizable or cross linkable liquid crystal compounds or moieties known as reactive mesogens (RM). For example, by including a reactive mesogen as a stabilizing polymerizable component in the LC mixture, i.e. a polymer stabilized liquid crystal (PSLC), the rigidity and resistance to laser fluence based reordering for a liquid crystal material in a light valve can be improved. In one embodiment, polymer stabilization can use a RM or monomer material miscible with the liquid crystal that takes on alignment of the solvent LC director field. Effectively, the monomer is a liquid crystal that enables some degree of crosslinking for other liquid crystal material. Using only a small amount of this material (for example, approximately 1 molar part in 40-50 molar), the liquid crystal and monomer mixture is polymerized (typically by UV curing process) into a fixed structure or liquid crystal network. This network provides a strong and covalently fixed alignment for the surrounding LC solvent.

In some embodiments, polymer stabilized liquid crystal devices enable faster switching at the cost of high scatter. A chain-extended (oligomer) liquid crystal mixed with a low molecular weight liquid crystal mixture enables softer liquid crystal polymer networks after polymerization and reduces scattering in the switched state because of lower density of crosslinks and reduced scattering cross section with equal mesogen content. This may be realized with both positive and negative dielectric monomer and may further use monofunctional mesogenic and non-mesogenic monomers. Furthermore, oligomer and low molecular weight liquid crystal may be chemically matched for improved miscibility, for example by using selective fluorination, and lessened scattering by reducing refractive index mismatch.

Advantageously, polymer stabilized liquid crystal devices can be used in many applications including but not limited to, liquid crystal displays (LCDs), light valves (LV), electrically or optically switchable LC cells, or optical shutters. Other uses include but are not limited to optical, electro optical or electronic devices or components such as optical retardation films, polarizers, compensators, beam splitters, reflective films, alignment layers, color filters, polarization controlled lenses for autostereoscopic 3D displays, RM lenses and IR reflection films for window applications, autostereoscopic 3D displays, organic light emitting diodes (OLEDs), optical data storage devices, and window applications.

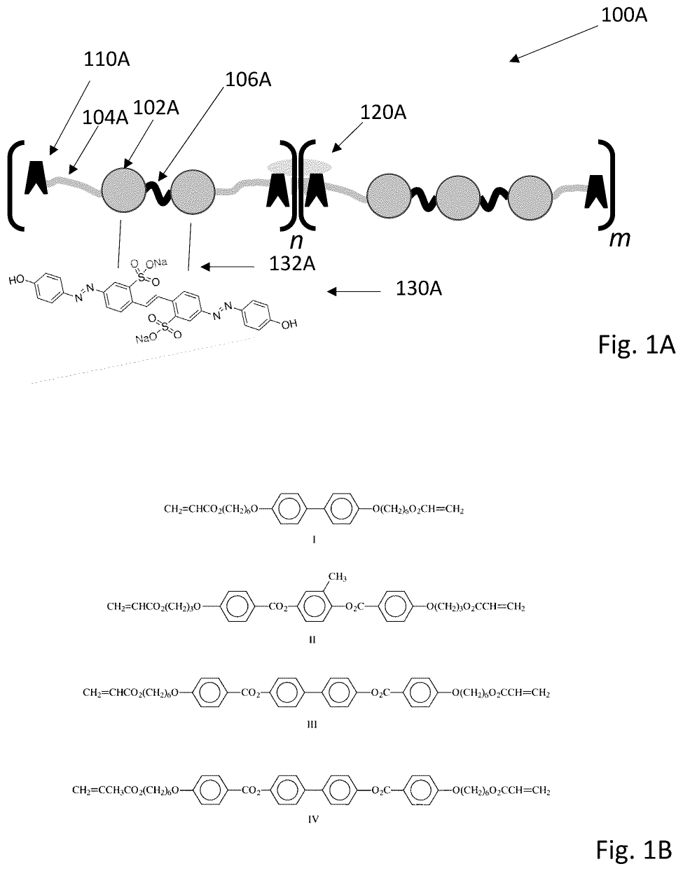

FIG. 1A illustrates a configurable LC crystal material 100 with reactive mesogens that can be tuned specific solubilities and functionality. As illustrated, core compound members 102A can be relatively stiff, including calamitic (rod- or board/lath-shaped) or discotic (disk-shaped) mesogenic groups. Core compound members 102A can include but are not limited to cyclic groups such as aromatic rings, aliphatic rings or heterocyclic rings. Examples of the aromatic rings include benzene ring and naphthalene ring. Examples of the aliphatic rings include cyclohexane ring. Examples of the heterocyclic rings include pyridine ring, pyrimidine ring, thiophene ring, 1,3-dioxane ring and 1,3-dithian ring. Optionally, one or more lateral groups can be attached to the mesogenic core compound members 102A, wherein these terminal and lateral groups are usually selected e.g. from carbyl or hydrocarbyl groups, polar groups like halogen, nitro, hydroxy, etc., or polymerizable groups.

Core compound members 102A can be connected to relatively mobile tails 104A that can be composed of long chain hydrocarbons. Tails 104A can include but are not limited to alkyl group having 1 to 40 carbon atoms, an alkoxy group having 1 to 40 carbon atoms, an acyl group having 2 to 40 carbon atoms, an alkoxycarbonyl group having 2 to 40 carbon atoms, an acyloxy group having 2 to 40 carbon atoms, an alkoxycarbonyloxy group having 2 to 40 carbon atoms, an alkylthio group having 1 to 20 carbon atoms, an amino group having 1 to 40 carbon atoms, an acylamino group having 2 to 40 carbon atoms, and an alkoxycarbonylamino group having 2 to 40 carbon atoms. These flexible substituent groups may be further substituted with other substituent groups. Examples of the substituent groups include: an alkyl group (e.g., methyl, ethyl, isopropyl, tert-butyl), an alkenyl group (e.g., vinyl, allyl, 2-butenyl, 3-pentenyl), an alkynyl group (e.g., propargyl, 3-pentynyl), an aryl group (e.g., phenyl, p-methylphenyl, naphthyl), a substituted or non-substituted amino group (e.g., non-substituted amino, methylamino, dimethylamino, diethylamino, anilino), an alkoxy group (e.g., methoxy, ethoxy, butoxy), an aryloxy group (e.g., phenyloxy, 2-naphthyloxy), an acyl group (e.g., acetyl, benzoyl, formyl, pivaloyl), an alkoxycarbonyl group (e.g., methoxycarbonyl, ethoxycarbonyl), an aryloxy-carbonyl group (e.g., phenyloxycarbonyl), an acyloxy group (e.g., acetoxy, benzoyloxy), an acylamino group (e.g., acetylamino, benzoylamino), an alkoxycarbonylamino group (e.g., methoxycarbonylamino), an aryloxycarbonylamino group (e.g., phenyloxycarbonylamino), an alkylsulfonylamino group (e.g., methanesulfonylamino), an arylsulfonylamino group (e.g., benzenesulfonylamino), a sulfamoyl group (e.g., sulfamoyl, N-methylsulfamoyl, N,N-dimethylsulfamoyl, N-phenylsulfamoyl), a carbamoyl group (e.g., non-substituted carbamoyl, N-methylcarbamoyl, N,N-diethylcarbamoyl, N-phenylcarbamoyl), an alkylthio group (e.g., methylthio, ethylthio), an arylthio group (e.g., phenylthio), an alkylsulfonyl group (e.g., mesyl), an arylsulfonyl group (e.g., tosyl), an alkylsulfinyl group (e.g., methane-sulfinyl), an arylsulfinyl group (e.g., benzenesulfinyl), an ureido group (e.g., non-substituted ureido, 3-methyl-ureido, 3-phenylureido), a phosphoric amido group (diethyl phosphoric amido, phenyl phosphoric amido), hydroxyl, mercapto, a halogen atom (e.g., fluorine, chlorine, bromine, iodine), cyano, sulfo, carboxyl, nitro, a hydroxamic acid group, sulfino, hydrazino, imino, a hetrocyclic group containing, for example, a heteroatom such as nitrogen, oxygen or sulfur (e.g., imidazolyl, pyridyl, quinolyl, furyl, piperidyl, morpholino, benzoxazolyl, benzimidazolyl, benzthiazolyl), and a silyl group (e.g., trimethylsilyl, triphenylsilyl). These substituent groups may be further-more substituted with themselves.

Core compound members 102A (with associated tails 104A) can be connected to each other by linkers 106A. Linkers 106A can include but are not limited to —O—, —S—, —CO—, —COO—, —OCO—, —S—CO—, —CO—S—, —O—COO—, —CO—NR00-, —NR00-CO—, —NR00-CO—NR00, —NR00-CO—O—, —O—CO—NR00-, —OCH₂—, —CH₂O—, —SCH₂—, —CH₂S—, —CF₂O—, —OCF₂—, —CF₂S—, —SCF₂, —CH₂CH₂—, —(CH₂)n1, —CF₂CH₂—, —CH2CF2-, —CF₂CF₂—, —CH—N—, —N—CH—, —N—N—, −CH—CR00-, —CY1-CY2-, —C≡C—, —CH—CH—COO—, —OCO—CH—CH— or a single bond, preferably —COO—, —OCO— or a single bond, more preferably —COO— or —OCO—.

The combination of previously described liquid crystal moieties 102A, 104A, and 106A can also include reactive functional groups 110A attached to tails 104A. In one embodiment, these can include acrylate polymers functioning as monoacrylates or diacrylates. Functional groups can include but are not limited to secondary amines, thiol, epoxide, alkyne, hydroxyl, carboxylic acid, vinyl, hydrosilane Advantageously, these functional groups can provide crosslinking sufficient to stabilize the liquid crystal material during operation with high fluence lasers.

In some embodiments, chain extenders 120A can be provided to link similar or differing liquid crystal materials 102A, 104A, and 106A. Chain extenders can include, but are not limited to moieties previously described as linkers 106A.

In one example chain extenders 120A can be used so that the number of repeats n and m could be controlled. Chain extenders may include functional groups such as primary or secondary amines, thiols, epoxide (glycidyl), alkyne, hydroxyl, carboxylic acid, vinyl, hydrosilane. This allows for assembly into designated blocks, other two dimensional or three dimensional structures, or can even be randomly ordered. In general, a wide range of combinations and permutations can be tuned by selection of particular liquid crystal materials and connectors to provide specific optical, thermal, and chemical stability properties. For example, an appropriate liquid crystal oligomer may reduce actuating voltage, improve (photo)alignment stability, while still maintaining high speed actuation in response to laser fluence.

In some embodiments, polymerization is achieved for example by exposing the liquid crystal material to heat or actinic radiation. Actinic radiation means irradiation with light, like UV light, IR light or visible light, irradiation with X-rays or gamma rays or irradiation with high energy particles, such as ions or electrons. In some embodiments a UV, IR or visible laser can be used. Curing time depends at least in part on the reactivity of the RMs, thickness of the coated layer, type of polymerization initiator used, and the type of actinic radiation. The polymerization process is not limited to one curing step. It is also possible to carry out polymerization by two or more steps, in which the liquid crystal material film is exposed to two or more lamps of the same type, or two or more different lamps in sequence. The curing temperature of different curing steps might be the same or different. The lamp power and dose from different lamps might also be the same or different. In addition to the conditions described above, the process steps may also include a heat step between exposure to different lamps. Preferably polymerization is carried out in air but polymerizing in an inert gas atmosphere like nitrogen or argon is also possible. The thickness of a liquid crystal polymer film according to the present invention is preferably less than 15 microns, very preferably less than 12 microns most preferably less than 10 microns.

The liquid crystal moieties 102A, 104A, and 106A can also be associated with photoalignment materials such as indicated with respective to photoalignment material 130A a representative, dichroic (i.e. polarization sensitive) dye. Advantageously, photoalignment material mixed, coated, or otherwise contacting liquid crystal can be stabilized (links 132A), allowing for use in high laser fluence applications. Photoalignment materials can include but are not limited to azobenezen, coumarin, cinnamate, anthracene, polyimides, methacrylamidoraryl. In some embodiments, photoalignment materials can be substituted in whole or in part with conventional rubbed alignment LCD material. Rubbed alignment LCD materials can be formed from suitable mesogens, and can include but are not limited to polyimides, polyamides, or polyvinylalcohols. Like photoalignment materials, rubbed alignment LCD materials similarly benefit from stabilizing contact with varying monomers combined into an oligomer for use in a stabilized liquid crystal device. In some embodiments, photoalignment materials or rubbed alignment LCD materials can be coated onto a substrate, partially dried, cured, or otherwise treated, and then further treated with reactive mesogens as discussed in this disclosure to provide a stabilizing oligomer suitable use in a liquid crystal device.

FIG. 1B illustrates various specific examples of reactive mesogens suitable for use in accordance with the present disclosure. These can include but are not limited to: 1B.I Acrylic acid 6-[4′-(6-acryloyloxy-hexyloxy)biphenyl-4-yloxy]hexyl ester (BAB6), 1B.II 1,4-Bis[4-(3-acryloyloxypropyloxy)benzoyloxy]-2-methylbenzene (RM257), 1B.III 4,4′-bis{4-[6-(acryloyloxy)hexyloxy]benzoate}biphenylene (BABB6), 1B.IV 4,4′-bis{4-[6-(methacryloyloxy)hexyloxy]benzoate}biphenylene (BMBB6). Other chemistries may include cyclohexyl groups and other common mesogenic cores as well as mixtures thereof. Further details are discussed with respect to Dierking, Ingo. “Polymer network-stabilized liquid crystals.” Advanced Materials 12.3 (2000): 167-181.

### EXAMPLE

In one example, an oligomer stabilized liquid crystal electro optical device can include use of the following material and procedures:

Materials:

E7 liquid crystal (Merck)

RM82 (1,4-Bis[4-(6-acryloyloxyhexyloxy)benzoyloxy]-2-methylbenzene)

nBA (n-Butylamine)

DMPA (2,2-Dimethoxy-2-phenylacetophenone, photoinitiator)

Procedure

In a small vial with stir bar, add in 2:1 molar ratio RM82 to nBA. Heat and stir in sealed vial at 105 C for 16 hours. This is the oligomerization process.

In a second vial add E7 liquid crystal with 5 weight % of RM82-nBA oligomer and 0.5 weight % DMPA. Mix thoroughly at 65 C.

This mixture can be infiltrated into an empty light valve or liquid crystal cell and then “UV cured”. UV cure by exposing to 365 nm light.

Tunable Parameters:

Molar ratio of monomer and linker (here RM82:nBA)

Oligomer composition selection (RM82, RM257, BAB6, etc.)

Linker molecule and method for oligomerization (amine Michael addition, thiol Michael addition, etc.)

Continuous phase liquid crystal (E7, E44, BL006, etc.)

Final properties of the device will depend on duration, temperature, and intensity of UV cure.

For compatibility with certain photoconductors, longer wavelength photoinitiators can be used (e.g. BAPO).

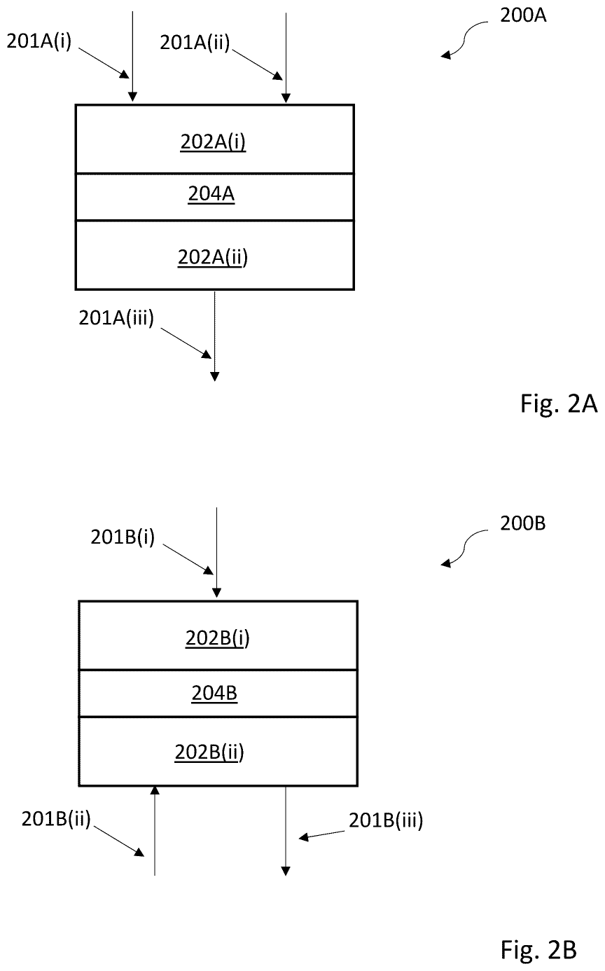

FIG. 2A illustrates a one embodiment of a high power capable transmissive light valve suitable for use in additive manufacturing systems or other application benefiting from long light valve lifetime when used at energy densities greater than 2 Joules/cm2, kW levels of power, 10's of Joules energy over many cm² area. In one embodiment, a transmissive light valve system 200A includes a liquid crystal layer 204A that can be formed from reactive mesogens as discussed herein and in conjunction with photoalignment materials. The liquid crystal layer 204A is positioned between first and second substrate 202A(i) and 202A(ii).

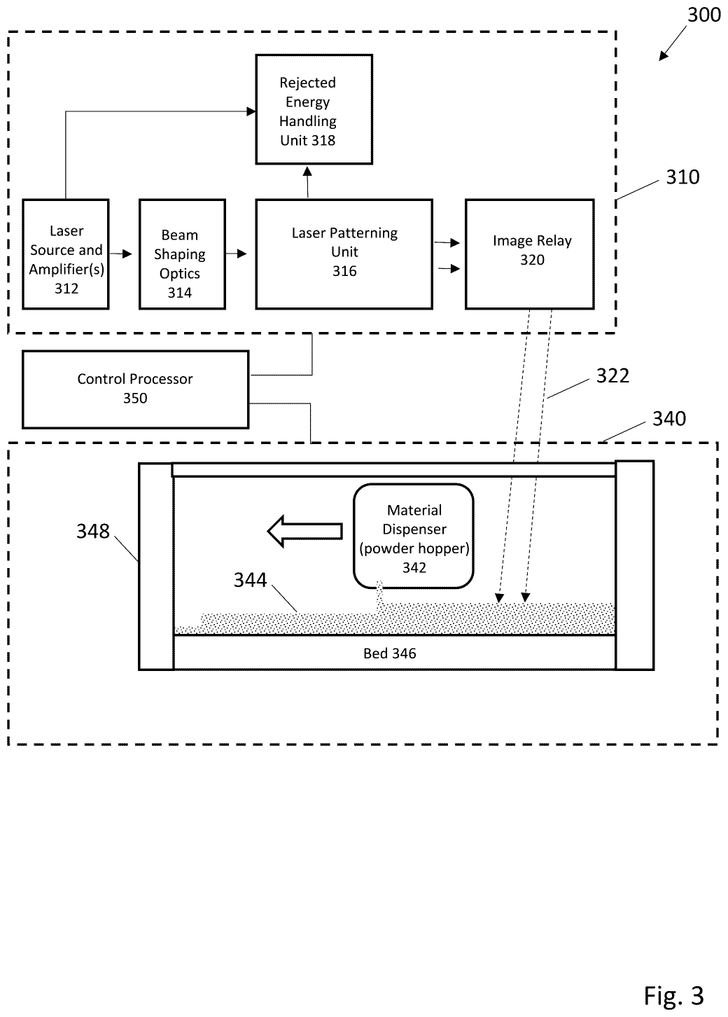

In operation, an addressing laser light 201A(i) can create a spatial pattern that, in combination with polarizers, selectively results in blocking or transmitting laser light passing through the laser light valve system 200A. A high fluence, high power, and high energy input light 201A(ii) is directed to pass through the laser light valve system 200A, is spatially patterned, and becomes output light 201A(iii). This light can be directed to heat a powder bed suitable for additive manufacturing as later described with respect to FIGS. 3, 4, and 5.

FIG. 2B illustrates a one embodiment of a high fluence, high power and high energy reflective light valve suitable for use in additive manufacturing systems or other application benefiting from long light valve lifetime when used at energy densities greater than 2 Joules/cm2. In one embodiment, a reflective light valve system 200B includes a liquid crystal layer 204B that can be formed from reactive mesogens as discussed herein and in conjunction with photoalignment materials. The liquid crystal layer 204B is positioned between first and second substrate 202B(i) and 202B(ii).

In operation, an addressing laser light 201B(i) creates a spatial pattern that selectively results in blocking or transmitting laser light reflecting through the laser light valve system 200B. A high fluence, high power, and high energy input light 201B(ii) is directed to pass into the laser light valve system 200B, is spatially patterned, reflected, and becomes output light 201B(iii). This light can be directed to heat a powder bed suitable for additive manufacturing as later described with respect to FIGS. 3, 4, and 5.

In another embodiment illustrated with respect to FIG. 3, additive manufacturing systems can be represented by various modules that form additive manufacturing method and system 300. As seen in FIG. 3, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate (Nd:YVO4) laser, Neodymium doped yttrium calcium oxoborateNd:YCa4O(BO3)3 or simply Nd:YCOB, Neodymium glass (Nd:Glass) laser, Titanium sapphire (Ti:sapphire) laser, Thulium YAG (Tm:YAG) laser, Ytterbium YAG (Yb:YAG) laser, Ytterbium:2O3 (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride (Ce:LiSAF, Ce:LiCAF), Promethium 147 doped phosphate glass (147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF2) solid-state laser, Divalent samarium doped calcium fluoride(Sm:CaF2) laser, or F-Center laser.

A Semiconductor Laser can include laser medium types such as GaN, InGaN, AlGaInP, AlGaAs, InGaAsP, GalnP, InGaAs, InGaAsO, GalnAsSb, lead salt, Vertical cavity surface emitting laser (VCSEL), Quantum cascade laser, Hybrid silicon laser, or combinations thereof.

As illustrated in FIG. 3, the additive manufacturing system 300 uses lasers able to provide one- or two-dimensional directed energy as part of an energy patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310 uses laser source and amplifier(s) 312 to direct one or more continuous or intermittent energy beam(s) toward beam shaping optics 314. After shaping, if necessary, the beam is patterned by a laser patterning unit 316 that can include a light valve system with a liquid crystal layer that can be formed from reactive mesogens as discussed herein and in conjunction with photoalignment materials. Generally some energy will be directed to a rejected energy handling unit 318 during the patterning process. Patterned laser energy is relayed by image relay 320 toward an article processing unit 340, in one embodiment as a two-dimensional image 322 focused near a bed 346. The article processing unit 340 can include a cartridge such as previously discussed. The article processing unit 340 has plate or bed 346 (with walls 348) that together form a sealed cartridge chamber containing material 344 (e.g. a metal powder) dispensed by powder hopper or other material dispenser 342. Dispensed powder can be created or recycled as discussed in this disclosure. Patterned energy, directed by the image relay 320, can melt, fuse, sinter, amalgamate, change crystal structure, influence stress patterns, or otherwise chemically or physically modify the dispensed and distributed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning. Such light valves can include light valve system a liquid crystal layer that can be formed from reactive mesogens as discussed herein and in conjunction with photoalignment materials.

Rejected energy handling unit 318 is used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

The material dispenser 342 (e.g. powder hopper) in article processing unit 340 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO2, N2, O2, SF6, CH4, CO, N2O, C2H2, C2H4, C2H6, C3H6, C3H8, i-C4H10, C4H10, 1-C4H8, cic-2, C4H7, 1,3-C4H6, 1,2-C4H6, C5H12, n-C5H12, i-C5H12, n-C6H14, C2H3Cl, C7H16, C8H18, C10H22, C11H24, C12H26, C13H28, C14H30, C15H32, C16H34, C6H6, C6H5-CH3, C8H10, C2H5OH, CH3OH, iC4H8. In some embodiments, refrigerants or large inert molecules (including but not limited to sulfur hexafluoride) can be used. An enclosure atmospheric composition to have at least about 1% He by volume (or number density), along with selected percentages of inert/non-reactive gasses can be used.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

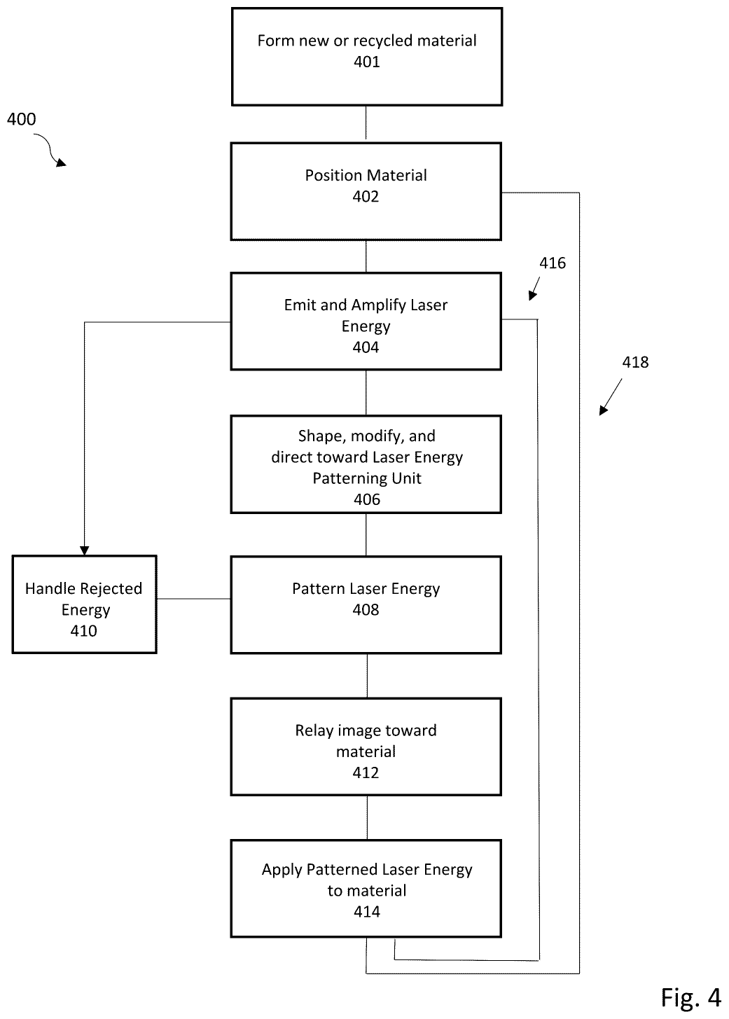

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components and that includes use of various optical diagnostic systems such as previously described herein. In step 401, material powder created or recycled as discussed in this disclosure is formed. In step 402, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned using a light valve system that includes a liquid crystal layer that can be formed from reactive mesogens as discussed herein and in conjunction with photoalignment materials, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. Information derived from applying patterned laser energy to a material can be used to identify powder size or other need diagnostics or measurements (step 415). For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

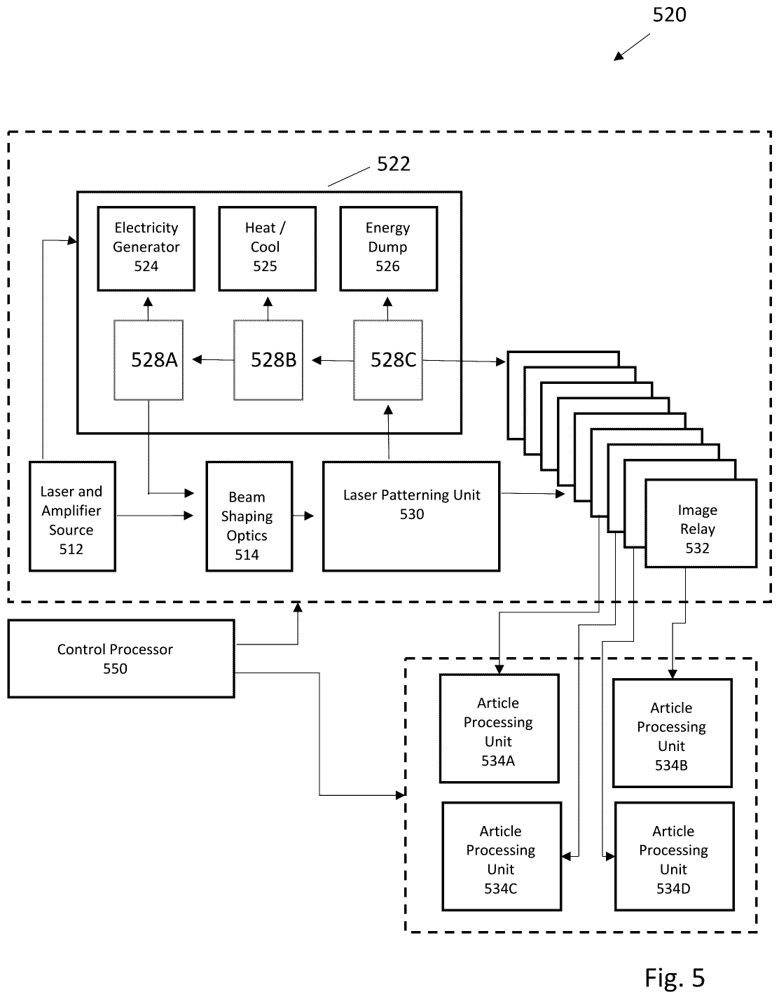

FIG. 5 is one embodiment of an additive manufacturing system that includes a phase change light valve system that includes a liquid crystal layer that can be formed from reactive mesogens as discussed herein and in conjunction with photoalignment materials. As previously noted with respect to FIG. 3, a switchyard system enables reuse of patterned two-dimensional energy. An additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units 534A-D. Advantageously, reuse of the patterned light can improve energy efficiency of the additive manufacturing process, and in some cases improve energy intensity directed at a bed or reduce manufacture time. In some embodiments, information derived from applying patterned laser energy to material in one or more of the article processing units 534A-D can be used to identify powder size or other needed diagnostics.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A light modifying composition, comprising
a first liquid crystal reactive mesogen material having attached functional groups that allow crosslinking;
a second liquid crystal reactive mesogen material having attached functional groups and a differing molecular weight from the first liquid crystal reactive mesogen material, with crosslinking between the first and second liquid crystal reactive mesogen material; and
at least one of a photoalignment material and a rubbed LCD alignment material contactable with the first and second liquid crystal reactive mesogen material.

2. The light modifying composition of claim 1, wherein the functional group is an acrylate.

3. The light modifying composition of claim 1, wherein the functional group is at least one of a monoacrylate and a diacrylate.

4. A light valve, comprising
a first transparent substrate and second substrate;
a liquid crystal material positioned between the first and second substrate, the liquid crystal material further comprising a first liquid crystal reactive mesogen material having attached functional groups that allow crosslinking, a second liquid crystal reactive mesogen material having attached functional groups and a differing molecular weight from the first liquid crystal reactive mesogen material, with crosslinking between the first and second liquid crystal reactive mesogen material, and at least one of a photoalignment material and a rubbed LCD alignment material contactable with the first and second liquid crystal reactive mesogen material.

5. The light valve of claim 4, wherein the functional group is an acrylate.

6. The light valve of claim 4, wherein the functional group is at least one of a monoacrylate and a diacrylate.

7. An additive manufacturing system, comprising
a light valve able to pattern a two dimensional light beam, the light valve including a first and second substrate;
a liquid crystal material positioned between the first and second substrate, the liquid crystal material further comprising a first liquid crystal reactive mesogen material having attached functional groups that allow crosslinking, a second liquid crystal reactive mesogen material having attached functional groups and a differing molecular weight from the first liquid crystal reactive mesogen material, with crosslinking between the first and second liquid crystal reactive mesogen material, and at least one of a photoalignment material and a rubbed LCD alignment material contactable with the first and second liquid crystal reactive mesogen material; and
a laser directable against the light valve for patterning.

8. The light valve of claim 7, wherein the functional group is an acrylate.

9. The light valve of claim 7, wherein the functional group is at least one of a monoacrylate and a diacrylate.

10. A powder bed additive manufacturing system, comprising
a light valve able to pattern a two dimensional light beam, the light valve including a first and second substrate;
a liquid crystal material positioned between the first and second substrate, the liquid crystal material further comprising a first liquid crystal reactive mesogen material having attached functional groups that allow crosslinking, a second liquid crystal reactive mesogen material having attached functional groups and a differing molecular weight from the first liquid crystal reactive mesogen material, with crosslinking between the first and second liquid crystal reactive mesogen material, and at least one of a photoalignment material and a rubbed LCD alignment material contactable with the first and second liquid crystal reactive mesogen material; and
a laser directable against the light valve for patterning before direction onto a powder bed.

11. The light valve of claim 10, wherein the functional group is an acrylate.

12. The light valve of claim 10, wherein the functional group is at least one of a monoacrylate and a diacrylate.
